(19) United States
(12) Patent Application Publication
(10) Pub. No.: US 2004/0069357 A1
(43) Pub. Date: Apr. 15, 2004

(54) Fluid control valves

(76) Inventors: John Ellacott, Devon (GB); John Hill, Somerset (GB); Sidney Western, Somerset (GB)

Correspondence Address: Blank Rome Cominsky & McCauley, The Farragut Building, Suite 1000, 900 17th Street NW, Washington, DC, 20006, US

(21) Appl. No.: 10/450,507

(22) PCT Filed: Dec. 14, 2001
(86) PCT No.: PCT/GB01/05530

(30) Foreign Application Priority Data
Dec. 16, 2000 (GB) 0030907.0
Aug. 29, 2001 (GB) 0120877.6

(51) Int. Cl. F16K 31/00

(52) U.S. Cl. 137/624.27

(57) ABSTRACT

An automatic fluid control valve assembly comprising a rotary valve which is changed from fully open to fully closed by rotation of an actuating shaft through approximately a right angle, a spring for rotating the shaft from a position where the valve is open to a position where the holds the valve is closed or vice versa, a trigger mechanism which holds the valve open or closed against the action of the spring, and a solenoid for actuating the trigger mechanism when the valve is to be opened or closed.

This invention concerns automatic fluid control valves and in particular such valves which can automatically turn the fluid flow on or off in response to an appropriate signal.

It is common practice in potable water systems to control fluid flow using manually operated valves, a wide variety of valves having been designed for the purpose. However, there are instances where turning the fluid flow on or off manually is impossible, for example where the valve is left unattended. Thus leakages can occur in water supplies to buildings when the buildings are unoccupied, leading to the environmentally undesirable consequences of the water going to waste and possibly to serious water damage to the building and its contents.

GB2179425-A describes an automatic valve system for use in a domestic water system in the form of a gate valve which is normally held open against the action of a compression spring, the valve being held open by a solenoid actuatable plunger which is biased by a compression spring into engagement with a recess in a shaft connected to the valve gate. If the duration of flow of water through the valve exceeds a predetermined period, the solenoid is activated to withdraw the plunger against the action of the associated compression spring, and the valve is automatically closed by the compression spring acting on the gate of the valve. The valve is reset manually by pulling on a knob on the shaft connected to the valve gate until the solenoid actuatable plunger is pushed by its associated compression spring into the recess in the shaft.

These prior art automatic valve systems suffer from the disadvantage that they are bulky due to the space required to operate the gate and more particularly to accommodate the shaft of the valve when the valve is open. In addition, the electrical energy required to activate the solenoid and withdraw the plunger against its associated compression spring is high, and so relatively large batteries are required for stand alone units. The rapid closure of the gate valve by its associated compression spring can also result so-called “water hammer” which can cause undesirable pressure changes in the system which in turn can lead to damage to the system.

According to the present invention there is provided an automatic fluid control valve assembly comprising a rotary valve which is changed from fully open to fully closed by rotation of an actuating shaft through approximately a right angle, a spring for rotating the shaft from a position where the valve is open to a position where the valve is closed or vice versa, a trigger mechanism which holds the valve open or closed against the action of the spring, and a solenoid for actuating the trigger mechanism when the valve is to be opened or closed.

Automatic fluid control valve assemblies in accordance with the present invention provide space advantages compared with the above prior art system based on a gate valve because opening and closing of the valve involves rotation rather than lateral movement of the valve shaft.

In addition, trigger mechanisms for holding the valve open or closed against the action of the spring for rotating the valve shaft from open to closed or vice versa can be used which require much lower actuating forces than are required to withdraw the prior art plungers against their associated compression springs.

The rotary valve used in assemblies according to the present invention can be ball valves, cylinder valves or butterfly valves, ball valves being particularly preferred.

The spring for rotating the shaft of the valve is preferably a coil or torsion spring disposed around the rotatable shaft of the valve. Such springs can be made from metal or plastics.

The trigger mechanism can take a variety of forms but it preferably includes a cam defining a cam surface attached to the shaft of the valve, and a pivotal lever having an end portion for engaging the cam surface to prevent rotation of the cam until the pivotal lever is rotated by the solenoid to disengage the said end portion of the pivotal lever from the said cam surface. The pivotal lever is preferably held in engagement with the cam surface and prevented from rotating by a hinged strut pivotally connected to an end portion of the pivotal lever remote from the end portion engaging the can surface.

The hinged strut is preferably substantially perpendicular to the pivotal lever as this tends to reduce the possibility of the trigger mechanism being set off when not required, for example due to mechanical vibration of the assemblies.

The solenoid is preferably pivotally connected to the hinge of the hinged strut, and in general a spring will be included for urging the hinged strut into a substantially straight configuration against the action of the solenoid, thereby resetting the trigger mechanism when the shaft of the rotatable valve is turned against the action of the spring.

Assemblies according to the present invention preferably include at least one stop for limiting rotation of the valve under the action of the spring for its rotation. This enables the valve to rotate from a fully open or closed position to a corresponding fully closed or open position after the shaft of the valve has been rotated through approximately a right angle following actuation of the trigger mechanism.

The present invention further provides an automatic fluid control device comprising an automatic fluid control valve assembly according to the present invention and a fluid flow sensor arranged to actuate the solenoid under predetermined conditions of fluid flow. Particularly preferred fluid flow sensors for use with automatic fluid control devices of the present invention are described in WO00/65314.

Embodiments of automatic fluid control valve assembly in accordance with the present invention will now be described with reference to the accompanying drawings in which:

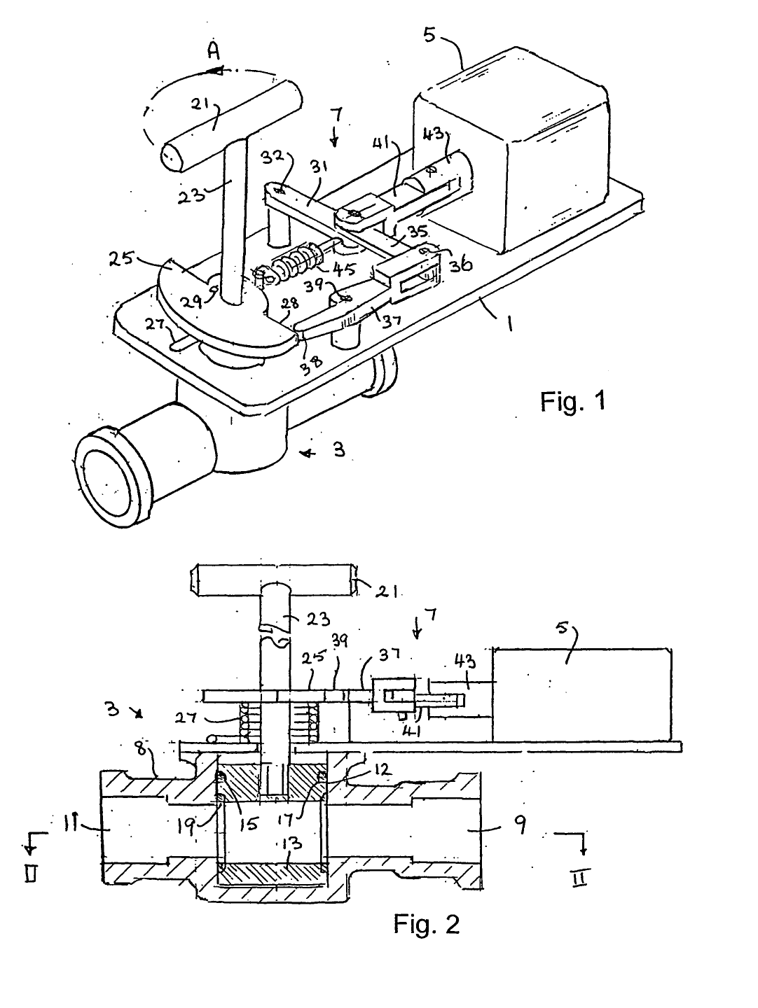

FIG. 1 is a perspective view of a first embodiment of valve;

FIG. 2 is a vertical section through the valve of FIG. 2;

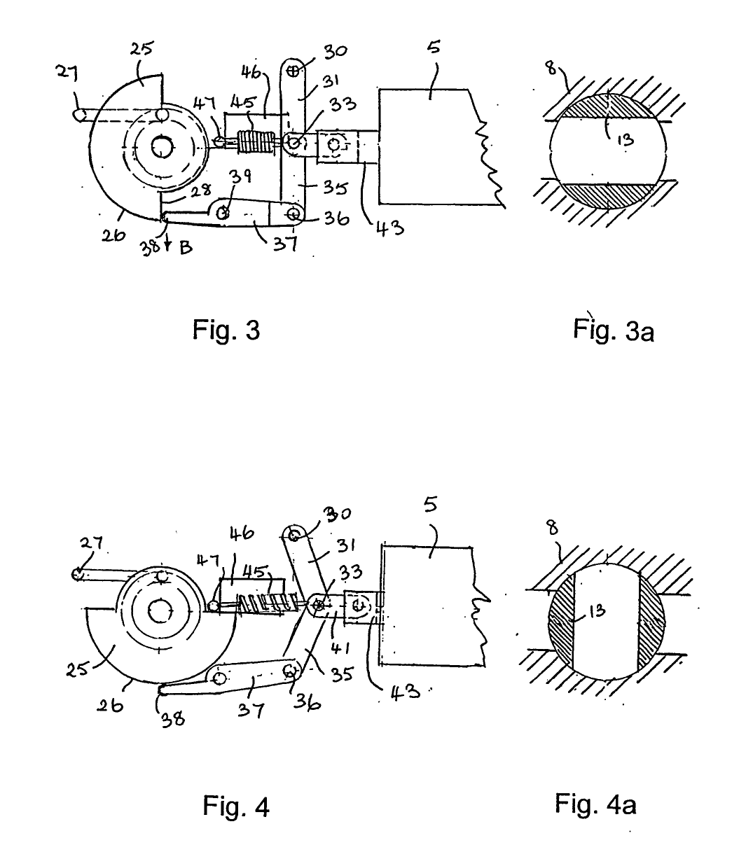

FIG. 3 is a plan view of the actuating mechanism of the valve of FIGS. 1 and 2 prior to operation of the valve;

FIG. 3a is a part cut away section on line II with the actuating mechanism as shown in FIG. 3;

FIG. 4 shows the mechanism of FIG. 3 after actuation of the valve;

FIG. 4a is a part cut away section on line II with the actuating mechanism as shown in FIG. 4;

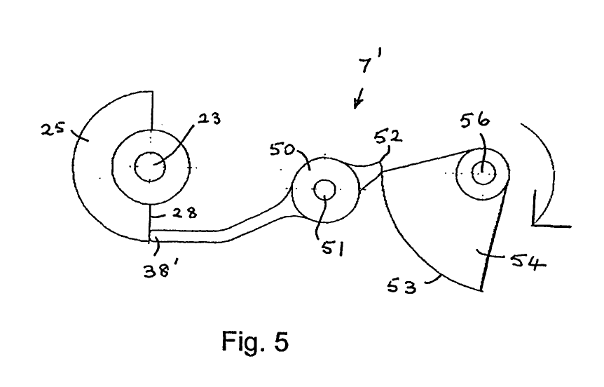

FIG. 5 shows part of an alternative actuating mechanism for a second embodiment of valve;

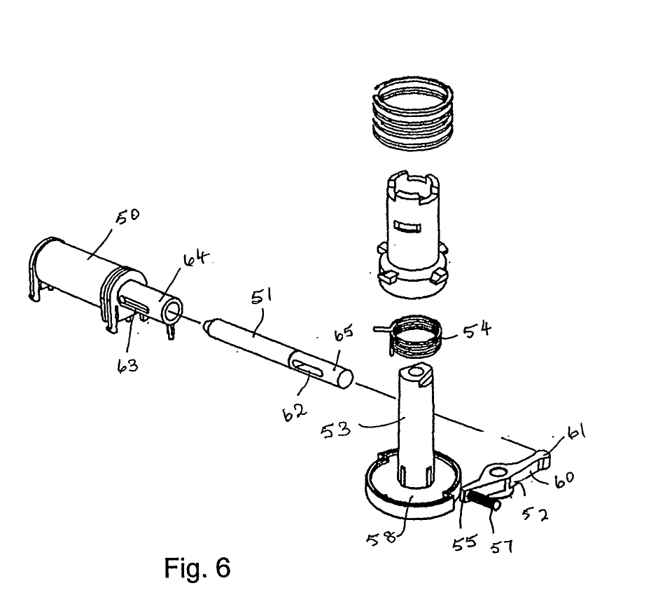

FIG. 6 is a perspective and exploded view of the actuating mechanism of a third embodiment of valve; and

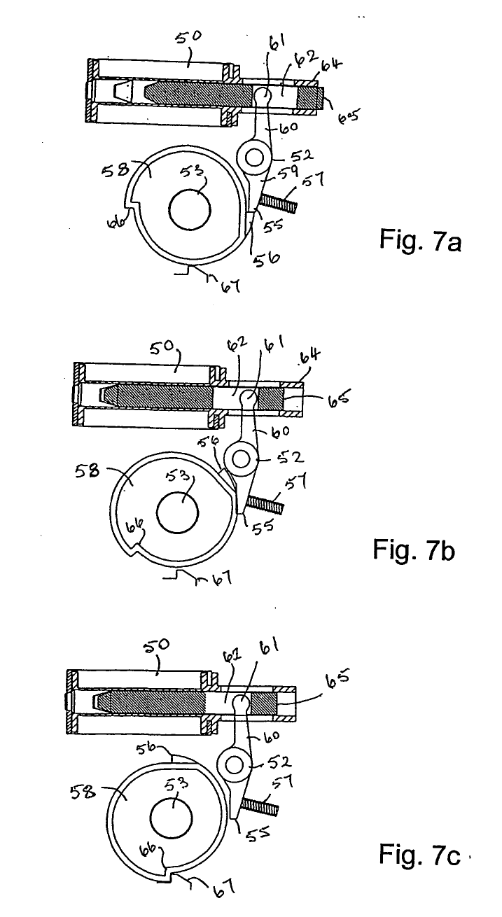

FIGS. 7a-c are plan views of the mechanism of FIG. 6 at various stages of the valve being closed.

The assembly shown in FIG. 1 consists of a base plate 1 to which are attached a cylinder valve 3, an actuating solenoid 5 having an armature 43, and a trigger mechanism shown generally at 7.

The cylinder valve 3, has a body portion 8 with an inlet 9, an outlet 11 and a cylindrical bore 12, and a cylindrical closure member 13. An “O”-ring seal 15 in an annular groove 17 in the cylindrical closure member 13 serves to prevent leakage of fluid from the valve. A further annular seal 19 disposed in a reduced diameter section of the cylindrical closure member 13 serves to provide fluid tight closure of the valve when in its closed position but to allow fluid flow when the valve is open.

A manual operating handle 21 for the valve 3 is connected to the cylindrical closure member 13 by a shank 23, and its function will be subsequently described in more detail. A cam plate 25 is fixed fast on the shank 23, so that the two rotate together. The cam plate 25 has a substantially semicircular cam surface 26 and two opposing and substantially radial cam surfaces 28 for purposes which will subsequently be described.

A coil spring 27 has one end located in an aperture (not shown) in the base plate 1 and its other end located in an aperture 29 in the cam plate 25, the spring 27 being located around the shank 23 between the base plate 1 and the cam plate 25. The spring 27 is pre-wound so that it urges the handle 21 in the rotational sense indicated by arrow A in FIG. 1. However, the shaft 23 is prevented from rotating by the trigger mechanism 7 as will subsequently be described in more detail.

The trigger mechanism 7, which is actuated by the solenoid 5, consists of three pivotally inter-connected levers. One end of a first of these levers 31 is pivotal about a first pivot 33 attached to the base plate 1 in addition to being pivotally connected to an intermediate lever 35, these levers being pivotal about a pivot pin 33. The intermediate lever 35 is in turn pivotally connected to a third lever 37 about a pivot pin 36, the third lever 37 also being pivotal about a second pivot 39. The first lever 31 and the intermediate lever 35 are shown in FIGS. 1 and 3 substantially in line, thereby forming a strut which is substantially perpendicular to the third lever 37.

FIG. 1 shows the valve assembly with the valve in its held open position, one of the radially extending cam surfaces 28 of the cam plate 25 bearing against a curved end portion 38 of the third lever 37 remote from its pivotal connection to the intermediate lever 35 under the action of the spring 27. Rotation of the shank 23, and therefore the valve mechanism, is prevented by the trigger mechanism 7 when it is in the configuration shown in FIGS. 1 and 3.

A draw bar 41 is also pivotal about the pivot pin 33, the draw bar 41 being pivotally connected to the armature 43 of the solenoid 5. A tension spring 45 is connected between the pivot pin 33 and a post 47 projecting upwardly from the base plate 1. Movement of the pivot pin 33 towards the shaft 23 is limited by a stop block 46 beneath the spring 45, the block 46 also serving to prevent rotation of the shaft 23 beyond the position shown in FIG. 4.

FIG. 3 shows the trigger mechanism 7 with the valve 3 held open by the mechanism 7, the cam plate 25 being prevented from rotating in the sense it is urged by the spring 27, and thereby close the valve 3, by the end portion of the third lever 37 bearing against the radially extending surface 28 of the cam plate 25.

Operation of the valve 3 is effected by actuating the solenoid 5, the armature 43 thereby being drawn into the solenoid 5 which in turn pulls the draw bar 41. As a result of the draw bar 41 being attached to the pivot 33 between the first lever 31 and the intermediate lever 35, pulling on the draw bar 41 caused by movement of the armature 43 rotates the first lever 31 in a counter clockwise sense about the pivot point 30 against the tension of the tension spring 45.

This rotation also results in movement of the intermediate lever 35 towards the solenoid 5. However, due to the third lever 37 to which the intermediate lever 35 is attached being prevented from movement other than rotationally about the pivot point 39, movement of the intermediate lever 35 towards the solenoid 5 causes the third lever 37 to rotate in a clockwise sense about the pivot 39 in the direction of arrow B.

The result is that the end portion 38 of the lever 37, on which radial surface 28 of the cam disc 25 bears to prevent rotation of the shank 23 when the valve is open slides radially outwardly of the shaft 23 until the surface 28 no longer bears on the end portion 38. The curvature of the end portion 38 of the third lever 37 serves to facilitate its sliding on the radial cam surface 28 when the trigger mechanism 7 is actuated. In addition it has been found that this sliding action can be improved by coating the cam surface 28 and/or the radial surface 28 with a polymeric layer.

The wound up spring 27 then shuts the valve 3, the trigger mechanism 7 then taking up the configuration shown in FIG. 4. The stop block 46 positioned on the base plate 1 prevents rotation of the shank 23 beyond the fully open position of the valve 3.

Resetting of the trigger mechanism 7 is merely effected by rotation of the handle 21 through 90° in a clockwise sense thereby rotating the shank 23 and the cam plate 25 so that the end portion 38 of the lever 37 at first slides along the cam surface 26 of the cam plate 25 and then radially inwardly of the cam plate 25 under the action of the tension spring 45. The strut formed by the first lever 31 and the intermediate lever 35 then becomes substantially straight and substantially perpendicular to the third lever 37.

As will be appreciated, instead of the valve 3 being held open by the trigger mechanism 7 as previously described, actuation of the trigger mechanism 7 using the solenoid 5 serving to close the valve, the valve 3 could be arranged so that with the trigger mechanism 7 set as shown in FIG. 3 the valve 3 is closed. Actuation of the trigger mechanism 7 would then serve to open the fluid flow through the valve 3.

The trigger mechanism shown in FIGS. 1-4 has been found to require a particularly low pulling force from the solenoid 5, particularly when compared with the prior art actuating mechanisms described above which require a solenoid to slide a spring biased actuator rod out of a groove in the operating shaft of a spring biased gate valve.

An alternative trigger mechanism which can be used in accordance with the present invention is shown in FIG. 5. In this case, the trigger mechanism 7′ consists of a crank 50 rotatable about a shaft 51 and biased in a clockwise sense by a wound up coil spring (not shown), a curved end portion 38′ of the crank 50 being in contact with the radial cam surface 28, thereby preventing the shaft 23 from rotating.

The opposite end portion 52 of the crank 50 is in contact with a cam surface 53 of a further cam 54 which increases in diameter from its rotational axis 56 when moving in a counter clockwise sense along the cam surface 53. As shown in FIG. 5, the end portion 52 of the crank 50 is curved to facilitate relative movement between it and the cam surface 34, and also as shown in FIG. 5, when the shaft 23 is prevented from rotating in an anticlockwise sense as a result of the radial surface 28 bearing on the end portion 38′ of the crank 50, the opposite end portion 52 of the crank 50 is in contact with a portion of the cam surface 53 having a relatively small radius. Rotation of the cam 54 in a clockwise sense urges the end portion 52 of the crank 50, and therefore the crank 50, in an anticlockwise sense which in turn causes the end portion 38′ to slide radially outwardly of the shaft 23 in a similar manner to the end portion 38 of the mechanism 7 shown in FIGS. 1-4.

A rotary solenoid (not shown) is connected to the shaft 56, and actuation of this solenoid triggers the trigger mechanism 7′ as described above.

The trigger mechanism 7′ is reset by rotation of the shaft 23 in an anticlockwise sense using the handle 21, the end portion 38′ of the crank 50 returning. to the position shown in FIG. 5 under the action of the coil spring acting on the crank 50.

The actuating mechanism shown in FIG. 6 and FIGS. 7a-c consists of a solenoid 50 having a ferromagnetic armature 51 which is slideable therein, a rotatable cam lever 52 actuatable by the armature 51, and a cam shaft 53.

The cam shaft 53 is secured to the shank (not shown) of the valve used to control water flow through the assembly, rotation of the cam shaft 53 through 90° changing the water flow through the valve from fully on to fully off, or vice versa, in a similar manner to that described in.relation to FIGS. 1-4.

A pretensioned tension spring 54 is biased to effect rotation of the cam shaft 53 in a counter clockwise sense as shown in FIG. 6, but prior to actuation of the mechanism an end portion 55 of the cam lever 52 this is prevented by the end portion 55 engaging a detent 56 on the external surface of a disc-like cam 58 forming part of the cam shaft 53. A compression spring 57 pressing against a first arm 59 of the cam lever 52 serves to urge the cam lever 52 in a clockwise sense, thereby retaining the end portion 55 of the lever 52 against the disc-like cam 58 which holds the valve fully open or closed.

A second arm 60 of the cam lever 52 has a rounded end portion 61 which as can be seen more clearly from FIGS. 7a-c is, in use, located within a slot 62 in a non-ferromagnetic, e.g. plastics, extension 65 of the ferromagnetic armature 51, and also in a guide slot 63 in a tubular extension 64 of the solenoid 50.

Operation of the actuating mechanism shown in FIGS. 6 and 7a-c will now be described with reference in particular to FIGS. 7a-c.

FIG. 7a shows the actuating mechanism in its armed position with the cam shaft 53 having been rotated in a clockwise sense until the end portion 55 of the cam lever 52 passes the detent 55 on the cam 58 and is pushed radially inwardly of the cam shaft by the compression spring 57 so that on release of the cam shaft 53, the cam shaft 53 is locked in its armed position against the tension in the tension spring 54.

Actuation of the solenoid 50 to effect actuation of the associated valve for controlling water flow draws the armature 51 into it, thereby causing the non-ferromagnetic extension 65 of the armature 51 to strike the rounded end portion 61 of the cam lever 52 and cause the end portion 55 of the cam lever 62 to slide off the detent 56 on the cam 58. The cam shaft 53 is then caused to rotate in a counter clockwise sense by the tension in the spring 54, and the end portion 55 of the cam lever 52 is caused to slide over the external surface of the cam 58 until a stop 67 is struck by a radially outwardly extending portion of the cam 58 as shown in FIG. 7c where the valve is fully closed or open depending on whether it was initially fully open or closed.

An intermediate position of the cam shaft 53 is shown in FIG. 7b.

The valve assembly shown in FIGS. 6 and 7a-c can be reset by simply manually turning the cam shaft 53 as described above, until the end portion 55 of the cam lever 52 is urged radially inwardly of the cam shaft 53 by the compression spring 57 into engagement with the detent 56.

Automatic fluid control valve assemblies in accordance with the present invention can be used in a variety of applications. For example, assemblies in which the valve is held in its open position by the trigger mechanism, actuation of the trigger mechanism closing the valve, can be used shut off domestic water supplies in the event of abnormal flows such as may be caused by leakages or a tap being left on for long periods of time. A detector which senses the flow of water in the supply can then be used to provide a signal to assemblies in accordance with the present invention and thereby actuates the solenoid and thence the trigger mechanism.

1. An automatic fluid control valve assembly comprising a rotary valve which is changed from fully open to fully closed by rotation of an actuating shaft through approximately a right angle, a spring for rotating the shaft from a position where the valve is open to a position where the valve is closed or vice versa, a trigger mechanism which holds the valve open or closed against the action of the spring, and a solenoid for actuating the trigger mechanism when the valve is to be opened or closed.

2. An assembly according to claim 1, wherein the valve is a ball valve, a cylinder valve or a butterfly valve.

3. An assembly according to either of the preceding claims, wherein the spring for rotating the shaft of the valve is a coil spring disposed around the shaft.

4. An assembly according to any of the preceding claims, wherein the trigger mechanism comprises a cam defining a cam surface attached to the shaft of the valve, and a pivotal lever having an end portion for engaging the cam surface to prevent rotation of the cam until the pivotal lever is rotated by the solenoid to disengage the said end portion of the pivotal lever from the said cam surface.

5. An assembly according to claim 4, wherein the pivotal lever is held in engagement with the cam surface and prevented from rotating by a hinged strut pivotally connected to an end portion of the pivotal lever remote from the end portion engaging the can surface.

6. An assembly according to claim 5, wherein the hinged strut is substantially perpendicular to the pivotal lever.

7. An assembly according to claim 5 or claim 6, wherein the solenoid is pivotally connected to the hinge of the hinged strut.

8. An assembly according to any of claims 5 to 7, including a spring for urging the hinged strut into a substantially straight configuration against the action of the solenoid.

9. An assembly according to any of the preceding claims, wherein the trigger mechanism comprises a cam defining a cam surface attached to the shaft of the valve, and a pivotal lever having an end portion for engaging the cam surface to prevent rotation of the cam until the pivotal lever is rotated by the solenoid to disengage the said end portion of the pivotal lever from the said cam surface, the solenoid having an armature with a non-ferromagnetic extension having a slot therein, an end portion of the pivotal lever being located in the slot in the extension of the armature.

10. An assembly according to claim 9, wherein actuation of the solenoid causes the non-magnetic extension of the armature to strike the end portion of the pivotal lever within the slot, thereby allowing the cam to rotate and operate the valve.

11. An assembly according to any of the preceding claims, including at least one stop for limiting rotation of the valve under the action of the spring for its rotation.

12. An automatic fluid control valve assembly substantially as herein described with reference to the accompanying drawings.

13. An automatic fluid control device comprising an automatic fluid control valve assembly according to any of the preceding claims and a fluid flow sensor arranged to actuate the solenoid under predetermined conditions of fluid flow.
